(19) United States
(12) Patent Application Publication
(10) Pub. No.: US 2024/0068554 A1
(43) Pub. Date: Feb. 29, 2024

(54) VEHICLE TRANSMISSION ASSEMBLY AND METHOD FOR ASSEMBLING A VEHICLE TRANSMISSION ASSEMBLY

(71) Applicant: VALEO EMBRAYAGES, Amiens (FR)

(72) Inventor: Fabien LEBEAU, Amiens (FR)

(73) Assignee: VALEO EMBRAYAGES, Amiens (FR)

(21) Appl. No.: 18/261,416

(22) PCT Filed: Jan. 17, 2022
(86) PCT No.: PCT/EP2022/050870

§ 371 Date: Jul. 13, 2023

(30) Foreign Application Priority Data
Jan. 18, 2021 (FR) FR2100435

(51) Int. Cl. F16H 57/02; H02K 5/15; H02K 7/116

(52) U.S. Cl. CPC F16H 57/02; H02K 5/15; H02K 7/116; F16H 2057/02034; F16H 2057/02043

(57) ABSTRACT

A transmission assembly for a vehicle includes an electric machine having a rotor rotatable about a first axis and a stator arranged radially outside the rotor, and a transmission device including a transmission shaft driven by the rotor and extending along the first axis. An output shaft and transmission mechanism are arranged to transmit torque between the transmission shaft and the output shaft. A transmission casing defines an internal space inside which is arranged at least part of the transmission mechanism. A stator support has an internal housing extending along the first axis of rotation, the stator being attached to the stator support inside this internal housing, the stator support being formed in a part separate from the transmission casing and includes an attachment zone attached to the transmission casing. The attachment zone being situated closer to the first axis of rotation than the stator.

### TECHNICAL FIELD

The invention relates to a transmission assembly, in particular for an electric or hybrid vehicle, and to its assembly method.

### PRIOR ART

In document FR3086124 A1, a front bearing of an electric machine housing is attached to a transmission casing. The attachment is carried out radially outside the electric machine and the attachment zones generate a detrimental additional bulk. However, compactness is an important design constraint for powertrains.

In addition, the front bearing, which also supports the stator, is rotatably mounted around the transmission shaft via a rolling bearing (see FIG. 2). The front bearing is therefore likely to absorb different forces, these forces possibly coming from the rotation of the rotor (unbalance) or of the reduction gear depending on the architecture of the powertrain.

It is also disclosed in this document to delimit a cooling chamber with a radially external face of the front bearing and a radially internal face of the rear bearing. The cooling chamber is insulated by seals arranged in grooves formed in the front bearing on either side of the cooling chamber.

The invention aims to remedy the drawbacks of the prior art and to propose a compact transmission assembly, while ensuring good sealing between the electric machine and the transmission mechanism (gearbox) and also at the cooling chamber. The invention also aims to facilitate the manufacture of this transmission assembly.

To do this, according to a first aspect of the invention, a transmission assembly for a vehicle is proposed, said transmission assembly comprising:
an electric machine comprising a rotor rotatable around a first axis of rotation (X) and a stator arranged radially outside the rotor,
a transmission device comprising a transmission shaft driven by the rotor and extending along the first axis of rotation X, an output shaft and a transmission mechanism arranged so as to transmit the torque between the transmission shaft and the output shaft,
a transmission casing defining an internal space inside which is arranged at least part of the transmission mechanism, in particular a toothed wheel driven by the transmission shaft,
a stator support having an internal housing extending along the first axis of rotation (X), the stator being attached to the stator support inside this internal housing,
a cooling chamber delimited in part by a radially external face of the stator support, the stator support comprising two annular grooves extending around the first axis of rotation (X) and arranged axially on either side of the cooling chamber, each annular groove accommodating an annular seal arranged so as to ensure sealing of the cooling chamber.

According to the invention, the stator support is formed in a part separated from the transmission casing and comprises an attachment zone attached to the transmission casing; the attachment zone being situated closer to the first axis of rotation (X) than the stator.

In other words, the attachment zone is situated radially inside the stator.

Thus, with the attachment zone being situated radially inside the stator, it is easily accessible before the introduction of the rotor and it does not generate additional bulk as when the attachment points are radially outside the stator.

Furthermore, having a stator support formed in a part separate from the transmission casing makes it easier to machine the grooves, in particular when the transmission casing has a portion radially covering the cooling chamber of the stator.

In addition, the transmission assembly is more modular and it is easier to customize the transmission assembly when changes must be made to the electric machine alone.

The transmission assembly may also comprise one or more of the following features:
The stator is substantially cylindrical and has an inside diameter situated at a first distance from the first axis of rotation X. The second distance separating the attachment zone from the first axis of rotation X is less than the first distance.
The transmission assembly also comprises an external electric machine envelope arranged radially outside the stator support; the cooling chamber being delimited in part by a radially internal face of the external electric machine envelope.
Preferably, the external electric machine envelope generally has a cylindrical or frustoconical shape extending along the first axis of rotation X.
Preferably, the cooling chamber generally has a cylindrical or frustoconical shape extending around the first axis of rotation X.
Preferably, the cylindrical or frustoconical cooling chamber is delimited solely by the external electric machine envelope and by the stator support.
According to one embodiment, the external electric machine envelope is formed in a part separate from the transmission casing, the part in which the external electric machine envelope is formed thus forming an electric machine casing.
According to another embodiment, the external electric machine envelope is formed in a cylindrical or frustoconical portion of the transmission casing extending axially. In other words, the external electric machine envelope is formed in one piece in the transmission casing.
If necessary, a cover closes this cylindrical portion of the transmission casing.
Preferably, a first bearing, in particular a first rolling bearing, is interposed radially between the transmission casing and the transmission shaft.
Preferably, the first bearing is housed in a wall of the transmission casing situated axially on the side of the electric machine.
Preferably, the first bearing is situated outside the internal space of the transmission casing. The internal space is sealed and is delimited by its walls and by the seals arranged in its openings.
Preferably, the first bearing is arranged radially inside the attachment zone of the stator support.
According to a variant, there is a plane perpendicular to the first axis of rotation X which intersects both the first bearing and the attachment zone of the stator support.
Preferably, the stator support is arranged at a distance from the first bearing. Thus, by not being in contact with the first bearing, the stator support does not absorb the forces coming from the shafts and gears of the transmission mechanism.
Preferably, the stator support comprises a flange arranged around the first axis of rotation X.
Preferably, the flange develops in a plane perpendicular to the first axis of rotation X.
Preferably, the attachment zone of the stator support is situated on this flange.
The attachment zone extends around the first axis of rotation X continuously or discontinuously.
The stator support and the transmission casing have a common connection interface; the common connection interface being formed on a plane, preferably a plane perpendicular to the first axis of rotation X. This plane passes if desired through the first bearing. In other words, there is a plane perpendicular to the first axis of rotation X passing through the common connection interface and the first bearing.
The stator support and the transmission casing are assembled against each other with assembly elements such as screws or rivets. Thus, each screwing or riveting zone forms a portion of the assembly zone which is then discontinuous around the first axis of rotation.
Alternatively, the transmission casing and the stator support are welded to each other continuously or discontinuously around the first axis of rotation X.
Preferably, the transmission casing comprises a connection zone cooperating with the attachment zone of the stator support, the connection zone comprising a first group of holes and the attachment zone of the stator support comprising a second group of holes arranged axially facing the first group of holes, and the assembly elements such as screws ensure the assembly of the stator support and the transmission casing.
Preferably, the holes of the first group of holes are blind holes. Thus, the sealing of the reduction gear is ensured.
The assembly elements are screws and the holes of the first group of holes are tapped.
Each assembly element cooperates with a blind hole.
The holes of the second group of holes may be through-holes.
Preferably, the holes of the first group of holes and the second group of holes extend axially.
Preferably, the stator support comprises a cylindrical portion in which the stator is push-fitted.
Preferably, the stator has an outside diameter D and the stator is carried by the stator support on its outside diameter D, in particular by shrink-fitting or push-fitting.
Preferably, the transmission casing comprises a first casing part having a first portion provided with the connection zone cooperating with the attachment zone of the stator support, and a second portion radially covering part of the external electric machine envelope so that there is a plane perpendicular to the first axis of rotation X which passes through the cooling chamber and which intersects the second portion of the first casing part. Thus, despite the presence of the second portion of the first casing part above at least one groove, the latter can be easily machined before mounting the stator support on the first casing part.
Where applicable, the first portion and the second portion of the transmission assembly each cover part of the transmission mechanism.
In other words, the first portion and the second portion of the first casing part are therefore made in one piece.
Preferably, a differential is arranged at least in part in the second portion of the first casing part. Thus, the design of the casing and of the stator support makes it possible to adapt to particular powertrain architectures, in particular with a differential arranged to overlap the electric machine. Also, having a common transmission casing part cooperating with the attachment zone and also enveloping all or part of the differential makes it possible to simplify the design and assembly of the powertrain as a whole.
A disconnection device capable of interrupting the transmission of the torque between the electric machine and the output shaft may also be arranged at least in part in the second portion of the first casing part.
The first casing part is provided with an opening through which the transmission shaft passes.
The first bearing is interposed radially between the first casing part and the transmission shaft.
The transmission assembly is an electric transmission axle or electric powertrain that can be mounted on an automobile front axle assembly or an automobile rear axle assembly.
The electric machine may be of the low-voltage or high-voltage synchronous or asynchronous type.
For example, the voltage of the electric machine is greater than or equal to 48V, for example greater than or equal to 72V.
According to one embodiment, the electric machine casing has a bell shape inside which are arranged the stator support, the stator, and the rotor.
Preferably, the electric machine casing or the cover comprises a bore inside which a second bearing, in particular a rolling bearing, is mounted, the transmission shaft being rotatably mounted relative to the electric machine casing or relative to the cover via this second bearing.
According to one embodiment, the transmission shaft comprises a first section and a second section abutting each other and mounted coupled in rotation with each other around the first axis of rotation X, for example by means of splines.
Preferably, the first section is mounted coupled in rotation with the rotor with respect to the first axis of rotation X, inside the rotor. In particular, the first section is attached directly to the rotor. Preferably, the second section is mounted coupled in rotation with a toothed wheel of the transmission mechanism.
The first section of the transmission shaft comprises a first end zone and a second end zone, the first end zone being mounted inside the first bearing and the second end zone being mounted inside the second bearing.
Preferably, the transmission casing has a first centering surface extending around the first axis of rotation X. If necessary, the stator support is centered on this first centering surface.
Preferably, the first centering surface is cylindrical, for example in the form of a right cylinder.
The stator support comprises a centering surface cooperating with the first centering surface of the transmission casing.
Preferably, the transmission casing has a second centering surface extending around the first axis of rotation (X). Where appropriate, the electric machine casing is centered on this second centering surface.
Preferably, the second centering surface is cylindrical, for example in the form of a right cylinder.
Preferably, the electric machine casing comprises a centering surface cooperating with the second centering surface of the transmission casing.
In particular, the centering surface of the electric machine casing is situated at the entrance to the bell, in other words in the opening in the bell which is the largest.
In particular, the centering surface of the electric machine casing and the hole in the electric machine casing are arranged axially facing each other.
Preferably, the first centering surface of the transmission casing faces radially inward.
Preferably, the second centering surface of the transmission casing faces radially outward.
Preferably, the transmission casing comprises a centering ring arranged around the first axis of rotation X and projecting axially toward the stator.
Preferably, the first centering surface is arranged on the radially internal face of this centering ring.
Preferably, the second centering surface is arranged on the radially external face of this centering ring.
According to one embodiment, the second portion of the first part of the transmission casing covers the two grooves.
Advantageously, the transmission mechanism comprises a reduction gear driven by the rotor of the electric machine via the transmission shaft.
Preferably, the output shaft extends parallel to the transmission shaft along a second axis of rotation Y.
According to one embodiment, a third annular groove is made in the stator support and an annular seal is arranged in this annular groove to ensure sealing between the stator support and the transmission casing. A cavity may be formed between this annular seal and the attachment zone of the stator support.
If applicable, the third groove is arranged radially facing the centering ring, inside the centering ring.

The invention also relates to a method for assembling a transmission assembly for a vehicle, said assembly method comprising the following steps:
providing a rotor and a stator of an electric machine,
providing a transmission device comprising at least part of a transmission shaft able to be driven by the rotor and extending along a first axis of rotation X, an output shaft and a transmission mechanism arranged so as to transmit the torque between the transmission shaft and the output shaft, and a transmission casing defining an internal space inside which is arranged at least part of the transmission mechanism, in particular a pinion driven by the transmission shaft,
providing a stator support comprising a cooling chamber delimited in part by a radially external face of the stator support, the stator support comprising two annular grooves extending around the first axis of rotation (X) and arranged axially on either side of the cooling chamber, each annular groove being able to accommodate an annular seal arranged so as to ensure sealing of the cooling chamber, the stator support being formed in a part separated from the transmission casing and the stator support comprising an attachment zone, the transmission casing comprising a connection zone cooperating with the attachment zone (140) of the stator support, the assembly method further comprising the following steps:
mounting the stator in the internal housing of the stator support (14) and attaching the attachment zone of the stator support to the connection zone of the transmission casing in such a way that the rotor and the stator extend along the first axis of rotation X, the attachment zone (140) being situated closer to the first axis of rotation (X) than the stator (12),
then mounting the rotor, which is rotatable about the first axis of rotation (X) and coupled in rotation with said at least part of the transmission shaft (19), radially inside the stator.

### BRIEF DESCRIPTION OF THE FIGURES

The invention will be understood better, and further aims, details, features and advantages thereof will become more clearly apparent, from the following description of a plurality of particular embodiments of the invention, which are given only by way of nonlimiting illustration, with reference to the appended drawings.

FIG. 1 is a schematic diagram of a transmission assembly corresponding to a first embodiment.

FIG. 2 is a sectional view of a transmission assembly according to the first embodiment.

FIG. 3 is a zoomed sectional view of the attachment zone of the transmission assembly of FIG. 2.

FIG. 4 is an exploded isometric view of the transmission assembly of FIG. 2.

FIG. 5 is a schematic diagram of a transmission assembly corresponding to a second embodiment.

### DESCRIPTION OF THE EMBODIMENTS

In the description and the claims, the terms “external” and “internal” and the orientations “axial” and “radial” will be used to denote elements of the transmission assembly according to the definitions given in the description. By convention, the first axis of rotation X of the transmission assembly determines the “axial” orientation and a “radial” orientation is directed orthogonally to the axial orientation by intersecting the first axis of rotation X. The “circumferential” orientation” is directed orthogonally to the first axis of rotation and orthogonally to a radial direction. The terms “external” and “internal” are used to define the relative position of one element with respect to another, with reference to the first axis X of rotation of the transmission assembly, an element close to the first axis of rotation X being thus qualified as internal as opposed to an external element situated radially at the periphery.

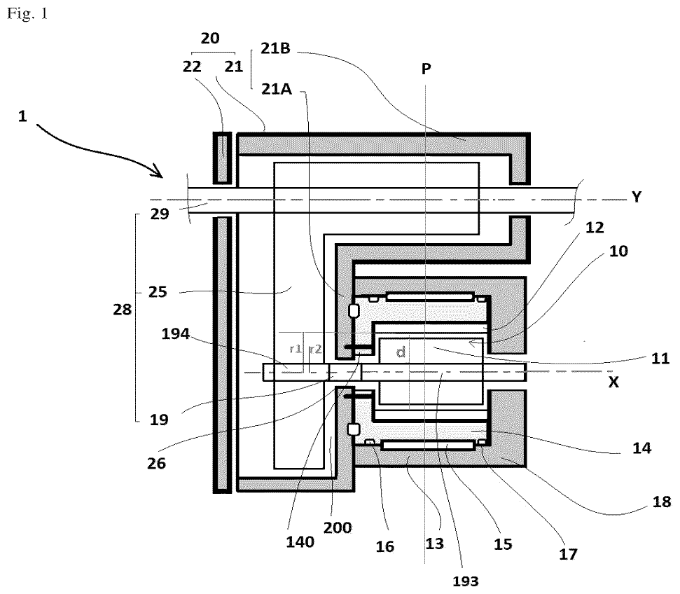

Described below, in relation to FIGS. 1 to 4, is a transmission assembly according to a first embodiment.

The schematic diagram of FIG. 1 shows a transmission assembly 1 for a vehicle in a simplified manner. This transmission assembly 1 comprises an electric machine 10 comprising a rotor 11 rotatable about a first axis of rotation X and a stator 12 arranged radially outside the rotor.

The transmission assembly 1 also comprises a transmission device 28 comprising a transmission shaft 19 driven by the rotor 11 and extending along the first axis of rotation X, and an output shaft 29 and a transmission mechanism 25 arranged so as to transmit the torque between the transmission shaft 19 and the output shaft 29.

A transmission casing 20 defines an internal space 200 inside which is arranged at least part of the transmission mechanism 25, in particular a toothed wheel driven by the transmission shaft 19.

The transmission assembly 1 also comprises a stator support 14 having an internal housing extending along the first axis of rotation X. The stator 12 is attached to the stator support 14 inside this internal housing.

A cooling chamber 15 is delimited in part by a radially external face of the stator support 14. The stator support 14 comprises two annular grooves 16 and 17 extending around the first axis of rotation X and arranged axially on either side of the cooling chamber 15. Each annular groove 16 and 17 can receive an annular seal arranged so as to ensure sealing of the cooling chamber 15.

The stator support 14 is formed in a part separate from the transmission casing 20 and comprises an attachment zone 140 attached to the transmission casing 20.

The attachment zone 140 is situated closer to the first axis of rotation X than the stator 12. In other words, the attachment zone 140 is situated radially inside the stator. Thus, the attachment zone 140 is easily accessible before the introduction of the rotor and it does not generate additional bulk, unlike the transmission assemblies whose corresponding attachment points are radially outside the stator.

The stator 12 is substantially cylindrical and has an inside diameter d situated at a first distance r1 from the first axis of rotation X. The second distance r2 separating the attachment zone 140 from the first axis of rotation X is therefore less than the first distance r1.

The transmission assembly also comprises an external electric machine envelope 13 arranged radially outside the stator support 14.

The cooling chamber 15 is delimited in part by a radially internal face of the external electric machine envelope 13. Here, the cooling chamber 15 is delimited only by the external electric machine envelope 13 and by the stator support 14.

In this diagram, the external electric machine envelope 13 and the cooling chamber 15 have a generally cylindrical shape extending along the first axis of rotation X.

According to the first embodiment, the external electric machine envelope 13 is formed in a part separate from the transmission casing 20. The part in which the external electric machine envelope 13 is formed here forms an electric machine casing.

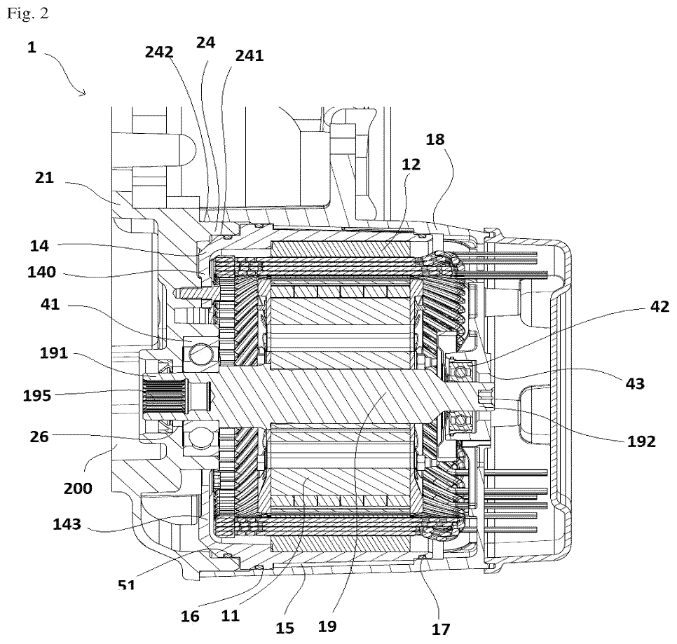

In FIG. 2, a first embodiment is shown in more detail. In this figure, it can be seen, for example, that the external electric machine envelope 13 and the cooling chamber 15 have a slightly frustoconical overall shape extending along the first axis of rotation X.

A first rolling bearing 41 is interposed radially between the transmission casing 20 and the transmission shaft 19. This first rolling bearing 41 is housed in a wall of the transmission casing situated axially on the side of the electric machine.

The first bearing 41 is situated outside the internal space 200 of the transmission casing 20. The internal space 200 is preferably sealed and is delimited by its walls and by the seals arranged in its openings.

The first bearing 41 is arranged radially inside the attachment zone 140 of the stator support 14. There is a plane perpendicular to the first axis of rotation X which intersects both the first bearing 41 and the attachment zone of the stator support. The stator support 14 is arranged at a distance from the first bearing 41. Thus, by not being in contact with the first bearing, the stator support does not absorb the forces coming from the shafts and gears of the transmission mechanism.

The stator support 14 and the transmission casing 20 have a common connection interface; the common connection interface being formed on a plane perpendicular to the first axis of rotation X. This plane passes through the first bearing 41.

As can be seen in FIG. 2, the stator support 14 comprises a flange 143 arranged around the first axis of rotation X and the attachment zone 140 of the stator support is situated on this flange 143. The flange 143 develops in a plane perpendicular to the first axis of rotation X.

The attachment zone may extend around the first axis of rotation X continuously or discontinuously.

In the embodiment shown in FIG. 2, the stator support 14 and the transmission casing 20 are assembled against each other with assembly parts such as screws or rivets. Thus, each screwing or riveting zone forms a portion of the assembly zone which is then discontinuous around the first axis of rotation.

Alternatively, the transmission casing and the stator support may be welded to each other continuously or discontinuously around the first axis of rotation X.

The transmission casing comprises a connection zone cooperating with the attachment zone 140 of the stator support 14. The connection zone of the transmission casing comprises a first group of holes and the attachment zone 140 of the stator support 14 comprises a second group of holes arranged axially facing the first group of holes, and a plurality of screws ensures the assembly of the stator support 14 and the transmission casing 20.

Advantageously, the holes of the first group of holes are blind holes. Thus, sealing with the transmission casing 20 is ensured at the attachment zone 140.

The holes of the second group of holes may be through-holes. The holes of the first group of holes and of the second group of holes preferably extend axially.

The stator support 14 comprises a cylindrical portion inside which the stator is push-fitted. The stator has an outside diameter D and the stator is carried by the stator support 14 on its outside diameter D, in particular by shrink-fitting or push-fitting.

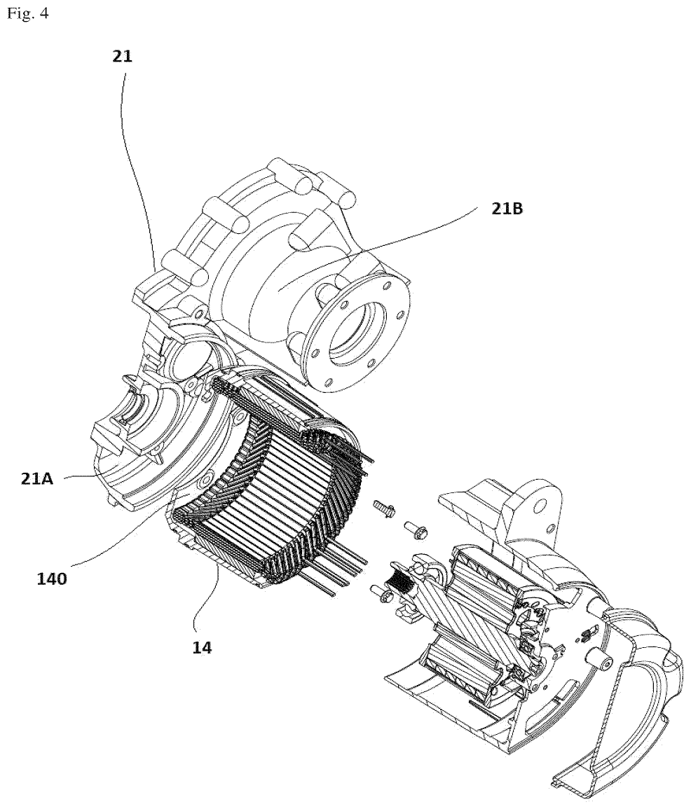

Reference should be made to FIGS. 1 and 4 to view the transmission assembly as a whole. The transmission assembly is an electric powertrain that can be mounted on an automobile front axle assembly or an automobile rear axle assembly. The electric machine may be of the low-voltage or high-voltage synchronous or asynchronous type. For example, the voltage of the electric machine is greater than or equal to 48V, for example greater than or equal to 72V.

Advantageously, the transmission mechanism comprises a reduction gear 20 driven by the rotor 11 of the electric machine 10 via the transmission shaft 19.

The output shaft of the transmission device extends parallel to the transmission shaft 19 (and to the first axis of rotation X) along a second axis of rotation Y.

It can be seen that the transmission casing 20 comprises a first casing part 21 having a first portion 21A provided with the connection zone cooperating with the attachment zone 140 of the stator support 14, and a second portion 21B radially covering part of the external electric machine envelope 13. In other words, the first portion 21A and the second portion 21B of the first casing part 21 are therefore made in one piece. There is a plane P perpendicular to the first axis of rotation X which passes through the cooling chamber 15 and which intersects the second portion 21B of the first casing part 21. Thus, despite the presence of the second portion of the first casing part 21 above the grooves 16 and 17, it may be easily machined before mounting the stator support 14 on the first casing part 21.

A differential is arranged at least in part in the second portion 21B of the first casing part 21. Having a common transmission casing part cooperating with the attachment zone and also enclosing the differential makes it possible to simplify the design and assembly of the powertrain as a whole.

The first casing part 21 is provided with an opening 26 through which the transmission shaft 19 passes. The first bearing 41 is interposed radially between the first casing part 21 and the transmission shaft 19.

It can be seen in FIG. 2 that the electric machine casing here has a bell shape inside which are arranged the stator support 14, the stator 12, and the rotor 11.

The electric machine casing comprises a bore inside which a second rolling bearing 42 is mounted, the transmission shaft being rotatably mounted relative to the electric machine casing via this second bearing.

The transmission shaft 19 comprises a first section 193 and a second section 194 butted to each other and mounted coupled in rotation with each other around the first axis of rotation X, for example by means of splines 195. The first section 193 is mounted coupled in rotation with the rotor 11 with respect to the first axis of rotation X, inside the rotor 11.

For its part, the second section is mounted coupled in rotation with a toothed wheel of the transmission mechanism.

The first section 193 of the transmission shaft 19 comprises a first end zone 191 and a second end zone 192, the first end zone being mounted inside the first bearing 41 and the second end zone being mounted inside the second bearing 42.

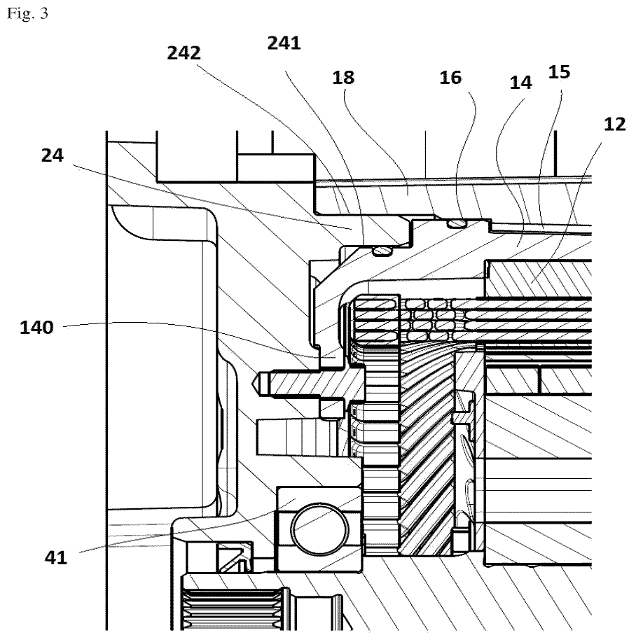

It can be seen in FIG. 3 that the transmission casing 20 has a first cylindrical centering surface 241 extending around the first axis of rotation X. The first centering surface 241 of the transmission casing 20 faces radially inward. The stator support 14 comprises a centering surface cooperating with the first centering surface 241 of the transmission casing.

The transmission casing 20 also has a second cylindrical centering surface 242 extending around the first axis of rotation X. The second centering surface 242 of the transmission casing 20 faces radially outward.

The electric machine casing comprises a centering surface cooperating with the second centering surface 242 of the transmission casing 20. The centering surface of the electric machine casing is situated at the entrance to the bell, in other words in the opening in the bell which is the largest. The centering surface of the electric machine casing and the hole 43 in the electric machine casing are arranged axially facing each other.

The transmission casing 20 comprises a centering ring 24 arranged around the first axis of rotation X and projecting axially toward the stator 12. The first centering surface 241 is arranged on the radially internal face of this centering ring 24. The second centering surface 242 is arranged on the radially external face of this centering ring 24.

In the first embodiment, a third annular groove 51 is made in the stator support 14 and an annular seal is arranged in this annular groove to ensure sealing between the stator support 14 and the transmission casing 20. A cavity may be formed between this annular seal and the attachment zone of the stator support. Here, the third groove is arranged radially facing the centering ring 24, inside the centering ring 24.

For assembly of the transmission assembly, the method comprises the following steps:
providing the rotor 11 and the stator 12 of the electric machine,
providing the transmission device 28 comprising at least part of the transmission shaft 19 able to be driven by the rotor 11 and extending along a first axis of rotation X, an output shaft 29 and a transmission mechanism 25 arranged so as to transmit the torque between said at least part of the transmission shaft 19 and the output shaft 29, and a transmission casing 20 defining an internal space 200 inside which is arranged at least part of the transmission mechanism 25, in particular a pinion driven by the transmission shaft 19,
providing a stator support 14 comprising a cooling chamber 15 delimited in part by a radially external face of the stator support 14, the stator support 14 comprising two annular grooves 16, 17 extending around the first axis of rotation X and arranged axially on either side of the cooling chamber 15, each annular groove 16, 17 being able to accommodate an annular seal arranged so as to ensure sealing of the cooling chamber 15, the stator support 14 being formed in a part separate from the transmission casing 20 and the stator support 14 comprising an attachment zone 140, the transmission casing comprising a connection zone cooperating with the attachment zone 140 of the stator support 14.

The assembly method further comprises the following steps:
mounting the stator in the internal housing of the stator support 14 and attaching the attachment zone of the stator support to the connection zone of the transmission casing in such a way that the rotor and the stator extend along the first axis of rotation X, the attachment zone 140 being situated closer to the first axis of rotation X than the stator 12,
then mounting the rotor, which is rotatable about the first axis of rotation X and coupled in rotation with said at least part of the transmission shaft 19, radially inside the stator.

As mentioned above, the rotor 11 is first secured to a first section 193 of the transmission shaft 19 before being butted to a second section 194 of the transmission shaft integrated beforehand in the transmission device 28.

The rotationally coupled connection between the two shaft sections may be ensured by complementary splines or by means of a junction piece such as a coupling sleeve.

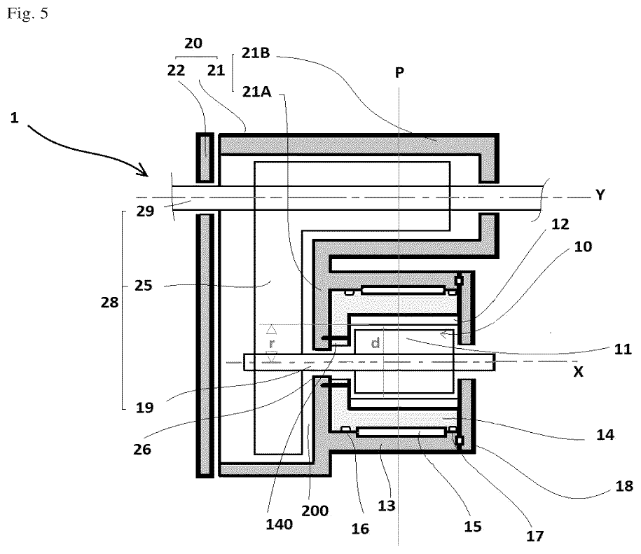

In the second embodiment shown in FIG. 5, the external electric machine envelope is formed in a cylindrical or frustoconical portion of the transmission casing 20 extending axially. In other words, the external electric machine envelope is formed in one piece in the transmission casing 20.

If necessary, a cover closes this cylindrical portion of the transmission casing and the second rolling bearing is then mounted between the first transmission shaft section and the cover to mount these two elements which are rotatable relative to each other with respect to the first axis of rotation X.

1. A transmission assembly for a vehicle, said transmission assembly comprising:
an electric machine comprising a rotor rotatable about a first axis of rotation and a stator arranged radially outside the rotor,
a transmission device comprising a transmission shaft driven by the rotor and extending along the first axis of rotation X, an output shaft and a transmission mechanism arranged so as to transmit the torque between the transmission shaft and the output shaft,
a transmission casing defining an internal space inside which is arranged at least part of the transmission mechanism, in particular a toothed wheel driven by the transmission shaft,
a stator support having an internal housing extending along the first axis of rotation, the stator being attached to the stator support inside this internal housing,
a cooling chamber delimited in part by a radially external face of the stator support, the stator support comprising two annular grooves extending around the first axis of rotation and arranged axially on either side of the cooling chamber, each annular groove accommodating an annular seal arranged so as to ensure sealing of the cooling chamber,
wherein the stator support is formed in a part separate from the transmission casing and comprises an attachment zone attached to the transmission casing; the attachment zone being situated closer to the first axis of rotation than the stator.

2. The transmission assembly as claimed in claim 1, also comprising an external electric machine envelope arranged radially outside the stator support; the cooling chamber being delimited in part by a radially internal face of the external electric machine envelope.

3. The transmission assembly as claimed in claim 2, wherein the external electric machine envelope is formed in a part separate from the transmission casing, the part in which the external electric machine envelope is formed thus forming an electric machine casing.

4. The transmission assembly as claimed in claim 2, wherein the external electric machine envelope is formed in a cylindrical or frustoconical portion of the transmission casing extending axially.

5. The transmission assembly as claimed in claim 1, wherein a first bearing, in particular a first rolling bearing, is interposed radially between the transmission casing and the transmission shaft.

6. The transmission assembly as claimed in claim 5, wherein the stator support is arranged at a distance from the first bearing.

7. The transmission assembly as claimed in claim 1, wherein the stator support comprises a flange arranged around the first axis of rotation, the attachment zone of the stator support being situated on this flange.

8. The transmission assembly as claimed in claim 1, wherein the stator support and the transmission casing are assembled one against the other with assembly elements such as screws or rivets.

9. The transmission assembly as claimed in claim 8, wherein the transmission casing comprises a connection zone cooperating with the attachment zone of the stator support, the connection zone comprising a first group of holes and the attachment zone of the stator support comprising a second group of holes arranged axially facing the first group of holes, and the assembly elements such as screws ensure the assembly of the stator support and the transmission casing, the holes of the first group of holes being blind holes.

10. The transmission assembly as claimed in claim 1, wherein the transmission casing comprises a first casing part having:
a first portion provided with the connection zone cooperating with the attachment zone of the stator support, and
a second portion radially covering part of the external electric machine envelope so that there is a plane perpendicular to the first axis of rotation which passes through the cooling chamber and which intersects the second portion of the first casing part; the first portion and the second portion of the transmission assembly each covering part of the transmission mechanism.

11. The transmission assembly as claimed in claim 10, wherein a differential is arranged at least in part in the second portion of the first casing part.

12. The transmission assembly as claimed in claim 3, wherein the transmission casing has a first centering surface extending around the first axis of rotation, the stator support comprising a centering surface cooperating with the first centering surface of the transmission casing; the transmission casing having a second centering surface extending around the first axis of rotation; the electric machine casing comprising a centering surface cooperating with the second centering surface of the transmission casing.

13. The transmission assembly as claimed in claim 12, wherein the transmission casing comprises a centering ring arranged around the first axis of rotation X and projecting axially toward the stator; the first centering surface being arranged on the radially internal face of this centering ring; and the second centering surface being arranged on the radially external face of this centering.

14. A method for assembling a transmission assembly for a vehicle, said assembly method comprising the following steps:
providing a rotor and a stator of an electric machine,
providing a transmission device comprising at least part of a transmission shaft able to be driven by the rotor and extending along a first axis of rotation X, an output shaft and a transmission mechanism arranged so as to transmit the torque between the transmission shaft and the output shaft, and a transmission casing defining an internal space inside which is arranged at least part of the transmission mechanism, in particular a pinion driven by the transmission shaft,
providing a stator support comprising a cooling chamber delimited in part by a radially external face of the stator support, the stator support comprising two annular grooves extending around the first axis of rotation and arranged axially on either side of the cooling chamber, each annular groove being able to accommodate an annular seal arranged so as to ensure sealing of the cooling chamber, the stator support being formed in a part separate from the transmission casing and the stator support comprising an attachment zone, the transmission casing comprising a connection zone cooperating with the attachment zone of the stator support,
the assembly method further comprising the following steps:
mounting the stator in the internal housing of the stator support and attaching the attachment zone of the stator support to the connection zone of the transmission casing in such a way that the rotor and the stator extend along the first axis of rotation X, the attachment zone being situated closer to the first axis of rotation than the stator,
then mounting the rotor, which is rotatable about the first axis of rotation and coupled in rotation with the transmission shaft, radially inside the stator.

15. The transmission assembly as claimed in claim 2, wherein a first bearing, in particular a first rolling bearing, is interposed radially between the transmission casing and the transmission shaft.

16. The transmission assembly as claimed in claim 2, wherein the stator support comprises a flange arranged around the first axis of rotation, the attachment zone of the stator support being situated on this flange.

17. The transmission assembly as claimed in claim 2, wherein the stator support and the transmission casing are assembled one against the other with assembly elements such as screws or rivets.

18. The transmission assembly as claimed in claim 2, wherein the transmission casing comprises a first casing part having:
a first portion provided with the connection zone cooperating with the attachment zone of the stator support, and
a second portion radially covering part of the external electric machine envelope so that there is a plane perpendicular to the first axis of rotation which passes through the cooling chamber and which intersects the second portion of the first casing part; the first portion and the second portion of the transmission assembly each covering part of the transmission mechanism.

19. The transmission assembly as claimed in claim 3, wherein a first bearing, in particular a first rolling bearing, is interposed radially between the transmission casing and the transmission shaft.

20. The transmission assembly as claimed in claim 3, wherein the stator support comprises a flange arranged around the first axis of rotation, the attachment zone of the stator support being situated on this flange.
